(19) United States
(12) Patent Application Publication
(10) Pub. No.: US 2013/0263993 A1
(43) Pub. Date: Oct. 10, 2013

(54) Pneumatic Tire

(71) Applicant: THE YOKOHAMA RUBBER CO., LTD., Tokyo (JP)

(72) Inventor: Masakazu Niwa, Hiratsuka-shi (JP)

(73) Assignee: The Yokohama Rubber Co., LTD., Tokyo (JP)

(21) Appl. No.: 13/856,374

(22) Filed: Apr. 3, 2013

(30) Foreign Application Priority Data
Apr. 4, 2012 (JP) 2012-085595

(51) Int. Cl. B60C 13/00

(52) U.S. Cl. CPC B60C 13/002
USPC 152/523

(57) ABSTRACT

A pneumatic tire includes a tread portion, a pair of side wall portions, and a pair of bead portions. A plurality of protectors is concentrically disposed continuously in the tire circumferential direction in the side wall portions projecting from the surface of the tire. Each protector is formed with a triangular shape in a tire meridian cross-section. An inclination angle α with respect to the tire radial direction of an inclining face from the apex of the protector outward in the tire radial direction is from 15° to 45°. An inclination angle β with respect to a tire axial direction of the inclining face from the apex of the protector inward in the tire radial direction is from 0° to 30°.

### PRIORITY CLAIM

Priority is claimed to Japan Patent Application Serial No. 2012-085595 filed on Apr. 4, 2012.

### BACKGROUND OF THE TECHNOLOGY

The present technology relates to a pneumatic tire with protectors in the side wall portion, and more particularly relates to a pneumatic tire in which damage to the protector itself is reduced, and the protective effect of the protector functions more effectively.

Pneumatic tires for traveling on unpaved roads are easily damaged in the side wall portion. Therefore in pneumatic tires that are used for this purpose, it has been proposed that a plurality of protectors is formed concentrically in the side wall portion projecting from the tire surface continuously in the tire circumferential direction (see Japanese Unexamined Patent Application Publication No. 2000-313209A and Japanese Unexamined Patent Application Publication No. 2003-11620A).

In the pneumatic tire as described above, in order to give the protector great strength, the shape of each protector in the tire meridian cross-section is a trapezoidal or semi-circular cylindrical shape. However, if the protector is contacted by a rock or sharp stone or the like, the protector itself will be damaged, and if the damage extends, it will reach the carcass layer. If the protector damage reaches the carcass layer, there is the problem that a breakdown such as a puncture or the like can easily occur.

### SUMMARY OF THE TECHNOLOGY

The present technology provides a pneumatic tire in which damage to the protector itself is reduced, and the protective effect of the protector functions more effectively.

The pneumatic tire according to the present technology comprises: an annular-shaped tread portion extending in a tire circumferential direction; a pair of side wall portions disposed on both sides of the tread portion; and a pair of bead portions disposed on an inner side in a tire radial direction of the side wall portions, wherein a carcass layer having at least one layer is mounted between the pair of bead portions, and a belt layer having a plurality of layers is disposed on the outer circumferential side of the carcass layer in the tread portion, wherein a plurality of protectors is concentrically disposed continuously in the tire circumferential direction in the side wall portions projecting from the surface of the tire; each protector is formed with a triangular shape in a tire meridian cross-section; an inclination angle α with respect to the tire radial direction of an inclining face from the apex of the protector outward in the tire radial direction is from 15° to 45°; and an inclination angle β with respect to a tire axial direction of the inclining face from the apex of the protector inward in the tire radial direction is from 0° to 30°.

In the present technology, the plurality of protectors is disposed concentrically and continuously in the tire circumferential direction on the side wall portion projecting from the tire surface, and the shape of each protector is a triangular shape having an acute angle on the tread portion side, so when a rock or a sharp stone or the like contacts the protector, the protector deflects the stone or sharp rock without absorbing the impact energy, and it is possible to minimize damage to the protector itself. Therefore, breakdowns such as punctures and the like caused by damage to the protectors reaching the carcass layer is prevented, and the protective effect of the protectors can function effectively.

In the present technology, preferably the spacing W between the apexes of the protectors is from 10 mm to 20 mm, and the height D of the protectors is from 3 mm to 8 mm. In this way, damage to the protector itself is minimized, and the protective effect of the protectors can be exhibited sufficiently.

Also, preferably the distance H1 in the tire radial direction from the apex of the protector located closest to the bead portion side to a position where the outer diameter of the tire is greatest is set in the range from 40% to 60% of the tire cross-section height SH, and the distance H2 in the tire radial direction from the apex of the protector located closest to the tread portion side to the position where the outer diameter of the tire is greatest is set in the range from 10% to 25% of the tire cross-section height SH. In this way, the protective effect of the protectors can be more effectively exhibited.

In addition, preferably the carcass layer includes not less than two layers, and the reinforcing cords of at least two layers of these carcass layers are arranged intersecting each other between layers. A carcass structure of this type has high rigidity which is effective for driving on unpaved roads or in competitions.

The pneumatic tire according to the present technology is ideal for traveling on unpaved roads, for use in competitions, and for use in four-wheel drive vehicles, although the present technology is not limited to these uses.

In the present technology, the various dimensions are measured with the tire assembled onto a regular rim and filled with the regular inner pressure. “Regular rim” is a rim defined by a standard for each tire according to a standards system that includes standards on which tires are based, for example, a standard rim for JATMA, a “design rim” for TRA, and a “measuring rim” for ETRTO. “Regular inner pressure” is an air pressure defined by standards for each tire according to a standards system that includes standards on which tires are based, for example, the maximum air pressure for JATMA, the maximum value in the table of “TIRE ROAD LIMITS AT VARIOUS COLD INFLATION PRESSURES” for TRA, and “INFLATION PRESSURE” for ETRTO and 180 kPa is applied when a tire is for a passenger vehicle.

### BRIEF DESCRIPTION OF THE DRAWINGS

FIG. 1 is a meridian cross-sectional view illustrating a pneumatic tire according to an embodiment of the present technology.

FIG. 2 is a view illustrating the contours of the pneumatic tire in FIG. 1.

FIG. 3 is a view illustrating the contours of the protector of the pneumatic tire in FIG. 1.

FIG. 4 is another view illustrating the contours of the protector of the pneumatic tire in FIG. 1.

FIG. 5 is a view illustrating the contours of a conventional pneumatic tire.

FIG. 6 is a view illustrating the contours of another conventional pneumatic tire.

### DETAILED DESCRIPTION OF THE EMBODIMENTS

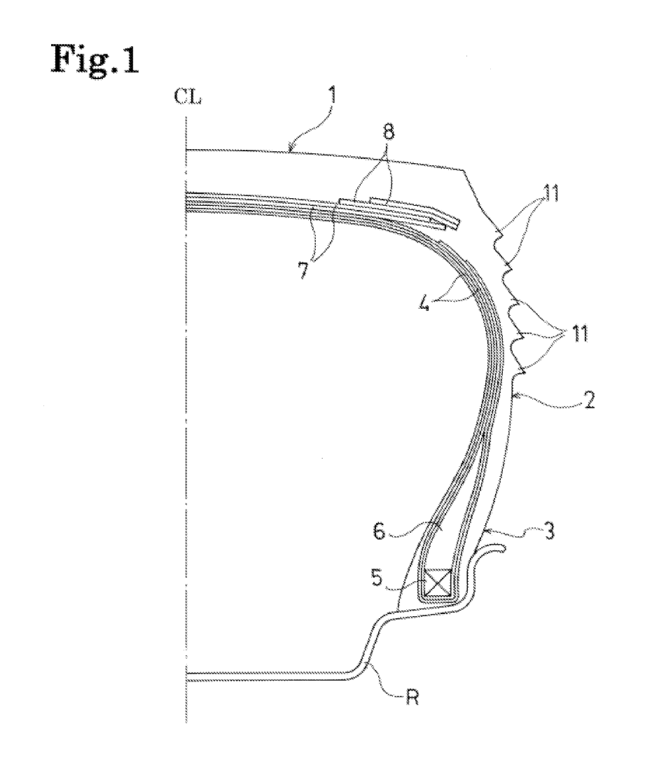

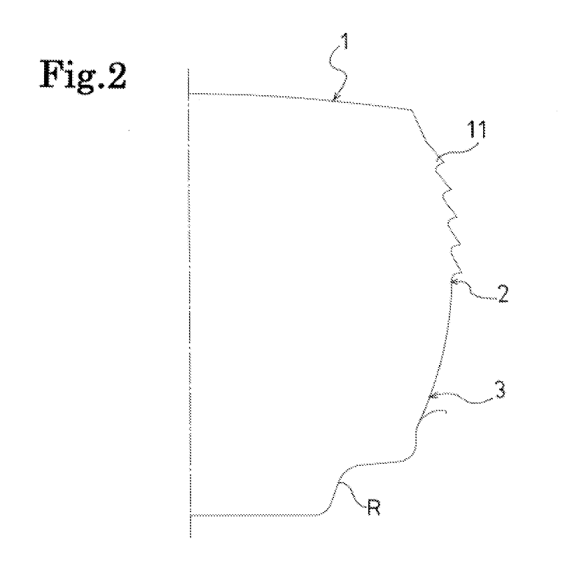

Detailed descriptions will be given below of a configuration of the present technology with reference to the accompanying drawings. FIGS. 1 to 4 illustrate a pneumatic tire according to an embodiment of the present technology. In FIG. 1, the pneumatic tire according to the present embodiment is depicted as the portion on one side bounded by the tire center line CL, however the pneumatic tire has a symmetrical structure on both sides of the tire center line CL. Also, R is the rim of a wheel on which the pneumatic tire is assembled.

As illustrated in FIG. 1, a pneumatic tire of the present embodiment is provided with a tread portion 1 extending in the tire circumferential direction to form an annular shape, a pair of side wall portions 2 that is disposed on both sides of the tread portion 1, and a pair of bead portions 3 that is disposed on the inner side in the tire radial direction of the side wall portions 2.

Two layers of a carcass layer 4 are mounted between the pair of bead portions 3,3. The carcass layer 4 includes a plurality of reinforcing cords that incline with respect to the tire radial direction and the reinforcing cords are disposed between the layers so as to intersect each other. In the carcass layer 4, the inclination angle of the reinforcing cords with respect to the tire radial direction is set in a range from, for example, 2° to 20°. The carcass layer 4 is folded back around a bead core 5 disposed in each of the bead portions 3 from the tire inner side to the tire outer side. Organic fiber cords are preferably used as the reinforcing cords of the carcass layer 4. A bead filler 6 having a triangular cross-sectional shape formed from rubber composition is disposed on a periphery of the bead core 5.

On the other hand, a plurality of layers of a belt layer 7 is embedded on an outer circumferential side of the carcass layer 4 in the tread portion 1. These belt layers 7 include a plurality of reinforcing cords that incline with respect to the tire circumferential direction and the reinforcing cords are disposed so as to intersect each other between the layers. In the belt layers 7, an inclination angle of the reinforcing cords with respect to the tire circumferential direction is set in a range from, for example, 10° to 40°. Steel cords are preferably used as the reinforcing cords of the belt layers 7. For the purpose of enhancing high-speed durability, at least one layer of a belt cover layer 8 formed by arranging reinforcing cords at an angle of not more than 5° with respect to the tire circumferential direction, is disposed on an outer circumferential side of the belt layers 7. A belt cover layer 8 preferably has a jointless structure in which a strip material made from at least one reinforcing cord laid in parallel and covered with rubber is wound continuously in the tire circumferential direction. Also, the belt cover layer 8 can be disposed so as to cover the belt layer 7 in the width direction at all positions, or can be disposed to cover only the edge portions of the belt layer 7 to the outside in the width direction. Nylon, aramid, or similar organic fiber cords are preferably used as the reinforcing cords of the belt cover layer 8.

Note that the tire internal structure described above is exemplary of a pneumatic tire, but is not limited thereto. Also, a plurality of grooves is formed as appropriate in the tread portion 1 in order to support traction and drainage.

In the pneumatic tire as described above, as illustrated in FIGS. 1 to 4, a plurality of protectors 11 is formed in the side wall portion 2 projecting from the tire surface S. The protectors 11 form a continuous annular shape in the tire circumferential direction, and are disposed concentrically with the rotational axis of the tire, which is not illustrated in the drawings, as the center. Each protector 11 has a triangular shape in the tire meridian cross-section, having an inclining face 51 that extends from the apex P outward in the tire radial direction, and an inclining face S2 that extends from the apex P inward in the tire radial direction. As illustrated in FIG. 4, the inclination angle α of the inclining face 51 with respect to the tire radial direction is in the range from 15° to 45°, or more preferably is in the range from 30° to 40°, and the inclination angle β of the inclining face S2 with respect to the tire axial direction is in the range from 0° to 30°, or more preferably is in the range from 5° to 15°. In other words, each protector 11 forms a triangular shape (wedge shape) with an acute angle on the tread portion side.

In the pneumatic tire as described above, the plurality of protectors 11 is disposed concentrically and continuously in the tire circumferential direction projecting from the tire surface S in the side wall portion 2, so when traveling on unpaved roads such as rough ground, the protectors 11 function to protect the side wall portion 2. Also, each protector 11 is formed in a triangular shape with an acute angle on the tread portion side, so when a rock or a sharp stone or the like contacts the protector 11, the protector deflects the stone or sharp rock without absorbing the impact energy, so it is possible to minimize the damage to the protector 11 itself. Therefore, breakdowns such as punctures and the like caused by damage to the protectors 11 reaching the carcass layer 4 are prevented, and the protective effect of the protectors 11 can function effectively.

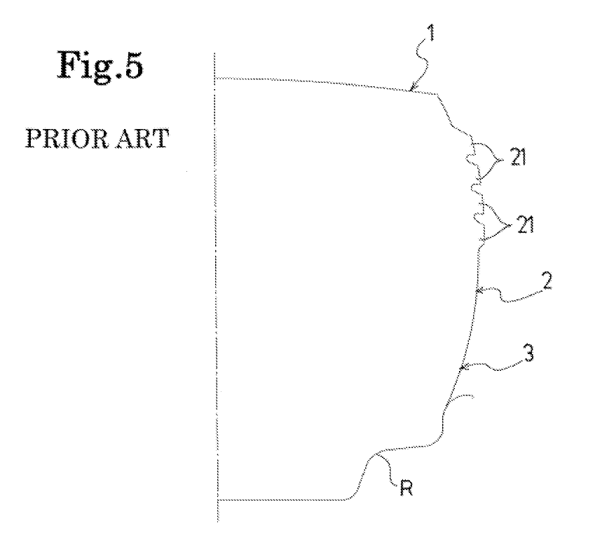

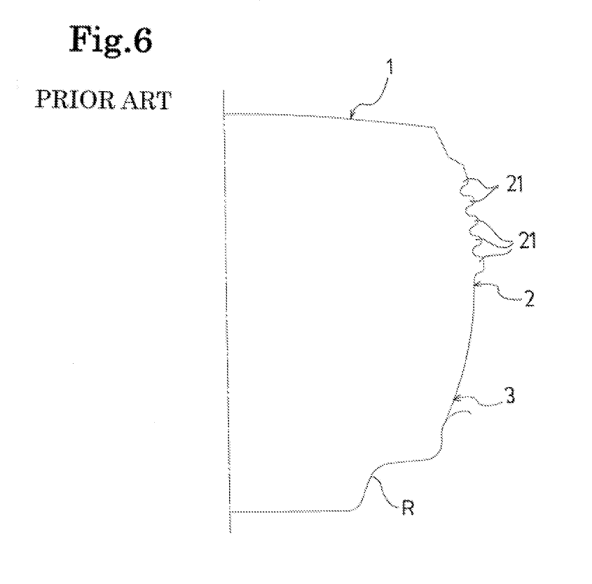

In contrast, when the cross-sectional shape of the protectors 21 is a trapezoidal shape (see FIG. 5) or semi-cylindrical shape (see FIG. 6) as in the conventional tire, when the protector 21 is contacted by a rock or a sharp stone or the like, the impact energy is received as it is, so the protector 21 itself is easily damaged. Also, when the damage to the protectors 21 reaches the carcass layer, there is a possibility that the damage will cause a breakdown such as a puncture or the like.

Here, when the inclination angle α with respect to the tire radial direction of the inclining face Si of the protectors 11 is less than the lower limit value, the protective effect of the protectors 11 is reduced, and conversely when it exceeds the upper limit value, the protector 11 can be easily damaged. Also, when the inclination angle β with respect to the tire axial direction of the inclining face S2 of the protectors 11 is less than the lower limit value, the protectors 11 can be easily damaged, and conversely when it exceeds the upper limit value, the protective effect of the protectors 11 is reduced.

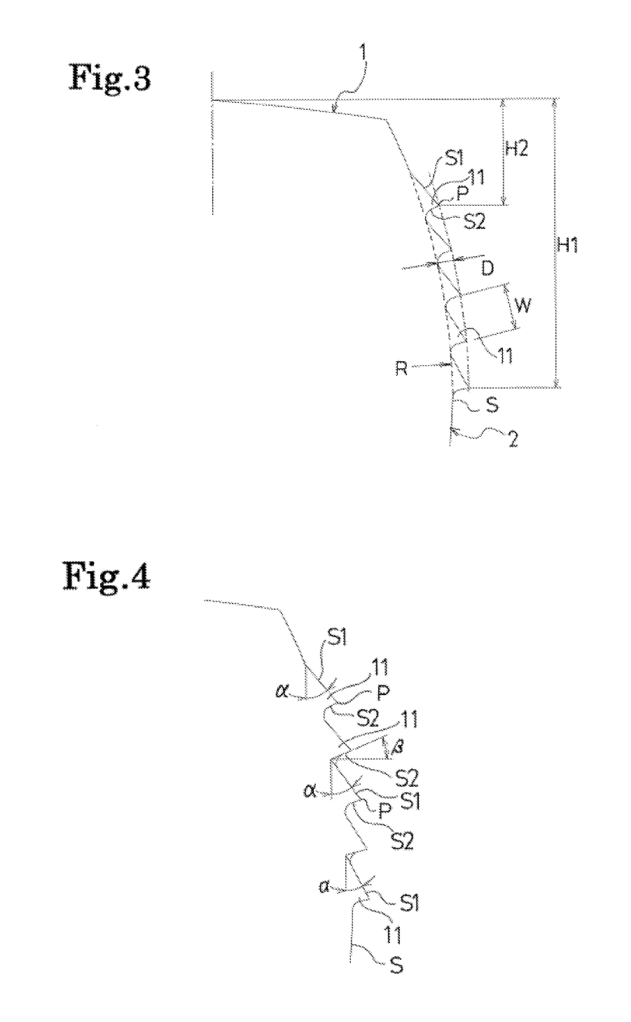

Also, in the pneumatic tire as described above, as illustrated in FIG. 3, the spacing W between the apexes P of the protectors 11 is in the range from 10 mm to 20 mm, and more preferably is in the range from 12 mm to 18 mm, and the height D of the protectors 11 is in the range from 3 mm to 8 mm, and more preferably is in the range from 4 mm to 6 mm. The height D of the protectors 11 is the protruding amount from the tire surface S, but the position of this tire surface S is based on a virtual curve drawn with a radius of curvature R in the tire meridian cross-section on the outer surface of the side wall portion 2.

By setting the spacing W of the apexes P of the protectors 11 and the height D of the protectors 11 in this way, damage to the protectors 11 can be minimized, and the protective effect of the protectors 11 can be sufficiently exhibited. Here, if the spacing W between the apexes P of the protectors 11 is less than the lower limit value, it is difficult to reduce the inclination angle α, so the protectors 11 are easily damaged. Conversely, if the upper limit value is exceeded, the protective effect due to the protectors 11 is reduced. Also, if the height D of the protectors 11 is less than the lower limit value, the protective effect of the protectors 11 is reduced. Conversely, if the upper limit value is exceeded, the protectors 11 are easily damaged.

In addition, in the pneumatic tire as described above, the distance H1 in the tire radial direction from the apex P of the protector 11 located closest to the bead portion side to the position where the outer diameter of the tire is greatest is in the range from 40% to 60% of the tire cross-sectional height SH, and more preferably is in the range from 45% to 55%, and the distance H2 in the tire radial direction from the apex P of the protector 11 located closest to the tread portion side to the position where the outer diameter of the tire is greatest is in the range from 10% to 25% of the tire cross-sectional height SH, and more preferably is in the range from 15% to 20%.

By making the region in which the protectors 11 are disposed appropriate in this manner, the protective effect of the protectors 11 can be more effectively exhibited. Here, if the protector 11 located closest to the bead portion side is disposed closer to the bead portion side than the above range, or if the protector 11 located closest to the tread portion side is disposed closer to the tread portion side than the above range, no additional protective effect can be expected, so it is wasteful. Also, if the protector 11 located closest to the bead portion side is disposed closer to the tread portion side than the above range, or if the protector 11 located closest to the tread portion side is disposed closer to the bead portion side than the above range, the protective effect of the protectors 11 is reduced.

In the pneumatic tire according to the embodiment as described above, the carcass layer has a two-layer structure, and these carcass layers are disposed so that the reinforcing cords intersect between layers, and this type of carcass structure has high rigidity and is effective for traveling on unpaved roads or for competitions such as races or the like. However, the present technology may be applied not only to pneumatic tires having the bias structure as described above, but can also be applied to pneumatic tires having a radial structure that has a single layer structure in the carcass layer where the carcass layer has the reinforcing cords disposed extending in the tire radial direction. In any case, the pneumatic tire as described above is suitable for driving on unpaved roads, for competitions, and for four-wheel drive use.

### EXAMPLES

Tires according to Working Examples 1 to 4 and Comparative Examples 1 to 6 were produced to tire size 205/65R15. In the pneumatic tires, a two-layer carcass layer was disposed between a pair of bead portions, a two-layer belt layer was disposed to the outer peripheral side of the carcass layer in the tread portion, and a two-layer belt cover layer (edge cover) was disposed on the outer peripheral side of the belt layer. As shown in FIG. 1, a plurality of protectors was disposed concentrically in the side wall portion continuously in the tire circumferential direction projecting from the tire surface, and each protector had a triangular shape in the tire meridian cross-section. The inclination angle α with respect to the tire radial direction of an inclining face from the apex of the protector outward in the tire radial direction, the inclination angle β with respect to a tire axial direction of the inclining face from the apex of the protector inward in the tire radial direction, the spacing W between protector apexes, the protector height D, the protector volume, the ratio of the distance H1 in the tire radial direction from the protector apex located closest to the bead portion side to the position where the outer diameter of the tire is greatest and the tire cross sectional height SH (H1/SH×100%), and the ratio of the distance H2 in the tire radial direction from the apex of the protector located closest to the tread portion side to the position where the outer diameter of the tire is greatest and the tire cross sectional height SH (H2/SH×100%) were set as shown in Table 1 and Table 2.

For comparison, Conventional Example 1 having a structure that was the same as Working Example 1 except that the cross-sectional shape of the protectors in the side wall portion were as illustrated in FIG. 5, Conventional Example 2 having a structure that was the same as Working Example 1 except that the cross-sectional shape of the protectors in the side wall portion were as illustrated in FIG. 6, and Conventional Example 3 having a structure that was the same as Working Example 1 except that no protectors were provided in the side wall portion were prepared.

The volume of protector is the volume of the portion of each protector projecting from the surface of the tire, and the volume of the protector closest to the tread portion side is P1, and successively towards the bead portion are P2, P3, P4, and P5. This volume is indicated as an index with the volume of the protector closest to the tread portion side in Conventional Example 1 being 100. Larger index values indicate larger volume of protector.

Also, in each test tire, nylon 66 fiber cord (1400 dtex/2) arranged at a cord density of 55 cords/50 mm was used as the carcass layer, steel cord (2+2×0.25 mm) arranged at a cord density of 40 cords/50 mm was used as the belt layer, and nylon 66 fiber cord (940 dtex/2) arranged at a cord density of 50 cords/50 mm was used as the belt cover layer. The width of the two layers of the belt cover layers was 25 mm and 35 mm, respectively.

The degree of damage in these test tires was evaluated by the evaluation methods described below, and the results are shown in Table 1 and Table 2.

### Degree of Damage:

Each test tire was assembled onto a wheel with a rim size 15×7.5 JJ and fitted to a 4-wheel drive vehicle with a 2000 cc displacement supercharged engine. With the test tires inflated to an air pressure of 180 kPa, a test driver drove the test vehicle for 160 km on an off-road (unpaved road) test course and a mountainous course that was used for testing (mountainous roads with rocks and sharp stones), and the occurrence of breakdowns was visually examined. The evaluation results were determined in 10 levels based on the following criteria.
1: Surface damage only (depth less than 1 mm)
2: Surface damage only (depth not less than 1 mm and less than 3 mm)
3: Surface damage only (depth not less than 3 mm and less than 5 mm)
4: Protector chipped (slight chip)
5: Protector chipped (major chip) or damage to a depth of not less than 5 mm
6: Protector chipped (fully removed)
7: Damage reaching to the carcass layer (exposing the outermost carcass layer)
8: Damage reaching to the carcass layer (slight damage to the carcass layer)
9: Damage reaching to the carcass layer (major damage to the carcass layer)
10: Burst (unable to travel 160 km)

TABLE 1

| | | Conventional | Conventional | Conventional | Working | Working | Working | Working |
|---|---|---|---|---|---|---|---|---|
| | | Example | Example | Example | Example | Example | Example | Example |
| | | 1 | 2 | 3 | 1 | 2 | 3 | 4 |
| Protector | | Present | Present | Absent | Present | Present | Present | Present |
| present or | | | | | | | | |
| absent | | | | | | | | |
| Protector shape | | FIG. 5 | FIG. 6 | — | FIG. 1 | FIG. 1 | FIG. 1 | FIG. 1 |
| Inclination | | — | — | — | 35 | 25 | 45 | 20 |
| angle α (°) | | | | | | | | |
| Inclination | | — | — | — | 5 | 15 | 25 | 30 |
| angle β (°) | | | | | | | | |
| Spacing W | | 7-10 | 9 | — | 10 | 15 | 15 | 20 |
| (mm) | | | | | | | | |
| Height D (mm) | | 5.0-2.0 | 4.0 | — | 4.8 | 4.0 | 5.8 | 3.7 |
| Protector | P1 | 100 | 89 | — | 63 | 77 | 77 | 88 |
| volume | P2 | 72 | 34 | — | 50 | 61 | 61 | 70 |
| (index | P3 | 55 | 34 | — | 50 | 61 | 61 | 70 |
| value) | P4 | 45 | 34 | — | 50 | 61 | 61 | 70 |
| | P5 | — | 58 | — | 50 | 61 | 61 | — |

| | | | | | | | |
|---|---|---|---|---|---|---|---|
| H1/SH × 100% | 15 | 15 | — | 15 | 10 | 25 | 10 |
| H2/SH × 100% | 50 | 50 | — | 50 | 60 | 40 | 60 |
| Degree of | 6 | 8 | 10 | 1 | 4 | 3 | 2 |
| damage | | | | | | | |

TABLE 2

| | | Comparative | Comparative | Comparative | Comparative | Comparative | Comparative |
|---|---|---|---|---|---|---|---|
| | | Example | Example | Example | Example | Example | Example |
| | | 1 | 2 | 3 | 4 | 5 | 6 |
| Protector | | Present | Present | Present | Present | Present | Present |
| present or | | | | | | | |
| absent | | | | | | | |
| Protector shape | | FIG. 1 | FIG. 1 | FIG. 1 | FIG. 1 | FIG. 1 | FIG. 1 |
| Inclination | | 50 | 14 | 35 | 50 | 14 | 35 |
| angle α (°) | | | | | | | |
| Inclination | | 20 | 0 | 35 | 20 | 0 | 35 |
| angle β (°) | | | | | | | |
| Spacing W | | 10 | 10 | 10 | 5 | 25 | 15 |
| (mm) | | | | | | | |
| Height D (mm) | | 7.2 | 1.0 | 3.7 | 3.5 | 3.0 | 5.7 |
| Protector | P1 | 97 | 11 | 49 | 24 | 73 | 113 |
| volume | P2 | 77 | 9 | 39 | 19 | 58 | 90 |
| (index | P3 | 77 | 9 | 39 | 19 | 58 | 90 |
| value) | P4 | 77 | 9 | 39 | 19 | 58 | 90 |
| | P5 | 77 | 9 | 39 | 19 | — | 90 |

| | | | | | | |
|---|---|---|---|---|---|---|
| H1/SH × 100% | 15 | 15 | 15 | 15 | 5 | 30 |
| H2/SH × 100% | 50 | 50 | 50 | 35 | 65 | 50 |
| Degree of | 5 | 5 | 5 | 6 | 6 | 6 |
| damage | | | | | | |

As can be seen from Table 1, the degree of damage of the tires according to Working Examples 1 to 4 is extremely low compared with Conventional Examples 1 to 3, in particular almost no damage to the protector was seen. On the other hand, the dimensions prescribing the shape of the protectors of the tires according to Comparative Examples 1 to 6 were outside the specified range, so the protective effect of the protectors was insufficient, and the improvement effect on the degree of damage was insufficient.

1. A pneumatic tire comprising an annular-shaped tread portion extending in a tire circumferential direction; a pair of side wall portions disposed on both sides of the tread portion; and a pair of bead portions disposed on an inner side in a tire radial direction of the side wall portions, wherein a carcass layer having at least one layer is mounted between the pair of bead portions, and a belt layer having a plurality of layers is disposed on the outer circumferential side of the carcass layer in the tread portion, wherein a plurality of protectors is concentrically disposed continuously in the tire circumferential direction in the side wall portions projecting from the surface of the tire; each protector is formed with a triangular shape in a tire meridian cross-section; an inclination angle α with respect to the tire radial direction of an inclining face from the apex of the protector outward in the tire radial direction is from 15° to 45°; and an inclination angle β with respect to a tire axial direction of the inclining face from the apex of the protector inward in the tire radial direction is from 0° to 30°.

2. The pneumatic tire according to claim 1, wherein: a spacing W between the apexes of the protectors is from 10 mm to 20 mm, and a height D of the protectors is from 3 mm to 8 mm.

3. The pneumatic tire according to claim 2, wherein: a distance H1 in the tire radial direction from the apex of the protector located closest to the bead portion side to a position where the outer diameter of the tire is greatest is set in a range from 40% to 60% of a tire cross sectional height SH, and a distance H2 in the tire radial direction from the apex of the protector located closest to the tread portion side to the position where the outer diameter of the tire is greatest is set in a range from 10% to 25% of the tire cross sectional height SH.

4. The pneumatic tire according to claim 3, wherein: the carcass layer has two or more layers, and the reinforcing cords of at least two layers of the carcass layers are arranged so as to intersect each other between the layers.

5. The pneumatic tire according to claim 4, wherein the pneumatic tire is an unpaved road traveling tire.

6. The pneumatic tire according to claim 4, wherein the pneumatic tire is a racing tire.

7. The pneumatic tire according to claim 4, wherein the pneumatic tire is a 4-wheel drive vehicle tire.

8. The pneumatic tire according to claim 2, wherein: the carcass layer has two or more layers, and the reinforcing cords of at least two layers of the carcass layers are arranged so as to intersect each other between the layers.

9. The pneumatic tire according to claim 8, wherein the pneumatic tire is an unpaved road traveling tire.

10. The pneumatic tire according to claim 8, wherein the pneumatic tire is a racing tire.

11. The pneumatic tire according to claim 8, wherein the pneumatic tire is a 4-wheel drive vehicle tire.

12. The pneumatic tire according to claim 1, wherein: a distance H1 in the tire radial direction from the apex of the protector located closest to the bead portion side to a position where the outer diameter of the tire is greatest is set in a range from 40% to 60% of a tire cross sectional height SH, and a distance H2 in the tire radial direction from the apex of the protector located closest to the tread portion side to the position where the outer diameter of the tire is greatest is set in a range from 10% to 25% of the tire cross sectional height SH.

13. The pneumatic tire according to claim 12, wherein: the carcass layer has two or more layers, and the reinforcing cords of at least two layers of the carcass layers are arranged so as to intersect each other between the layers.

14. The pneumatic tire according to claim 13, wherein the pneumatic tire is an unpaved road traveling tire.

15. The pneumatic tire according to claim 13, wherein the pneumatic tire is a racing tire.

16. The pneumatic tire according to claim 13, wherein the pneumatic tire is a 4-wheel drive vehicle tire.

17. The pneumatic tire according to claim 1, wherein: the carcass layer has two or more layers, and reinforcing cords of at least two layers of the carcass layers are arranged so as to intersect each other between the layers.

18. The pneumatic tire according to claim 17, wherein the pneumatic tire is an unpaved road traveling tire.

19. The pneumatic tire according to claim 17, wherein the pneumatic tire is a racing tire.

20. The pneumatic tire according to claim 17, wherein the pneumatic tire is a 4-wheel drive vehicle tire.
